(19) United States
(12) Patent Application Publication
(10) Pub. No.: US 2012/0241366 A1
(43) Pub. Date: Sep. 27, 2012

(54) Particulate and Bypass Filter and Locomotive Oil Lube Filtration System

(75) Inventors: Ian Joseph Derstler, Columbia, PA (US); Richard Kurcina, Lancaster, PA (US); Scott Nemeth, Lancaster, PA (US)

(73) Assignee: CLARK FILTER, INC., Lancaster, PA (US)

(21) Appl. No.: 13/053,538

(22) Filed: Mar. 22, 2011

(51) Int. Cl. B01D 29/50; B01D 29/52; B01D 29/56; B01D 27/08

(52) U.S. Cl. 210/232; 210/323.1; 210/323.2; 210/335

(57) ABSTRACT

A bypass filter cartridge is provided having a low efficiency filter element and a high efficiency filter element oriented in either parallel or series. The low efficiency filter element may comprise pleated filter sheet while the high efficiency filter element may include a tubular ring of depth media with considerable thickness or pleated media of varying types. The filter cartridge may be adapted and configured for use in specialized locomotive oil lubrication circuits with substantial benefit therein.

### FIELD OF THE INVENTION

This invention generally relates to filters and more particularly relates to particulate and bypass filters wherein part of fluid flow bypasses at least part of the fluid flow; and/or in some aspects relate to the special application environment of locomotive oil lube filtration systems.

### BACKGROUND OF THE INVENTION

The oil lube filtration art specifically for locomotive engines is specialized in that very large filtration systems are employed requiring a high level of lubrication flow capacity to meet the large system requirements of these massive engines. Often, multiple filter elements are arranged in parallel circuit within a common single housing; each filter element being mounted to a stem pipe. An example of an arrangement is disclosed in US Publication No. 2010/0051528 to Derstler et al, the entire disclosure of which is hereby incorporated by reference. One typical arrangement may include an array of 10 filters all arranged in the same housing. The filter elements can be removed and replaced. To provide for capacity, these locomotive filter elements are long, typically at least about 18 inches in many of the applications, more typically at least 24 inches, and sometimes 40 inches or more. To provide for fluid flow, these filter elements have an open cellulose based pleated filter medium with an open pore structure with a common filtration rating of 30 micron, thereby providing an open pore structure while facilitating fluid flow.

It is believed, however, that while such an open pleated filter medium may provide for sufficient flow capacity, it can also lead over extended operation times to eventual wear on parts the placement of engine components from smaller particulate components.

Outside of the locomotive oil lubrication art, there are also known a variety of other types of much smaller filter elements that are typically arranged in series, and singly within a lubrication circuit of small engines such as for over the road vehicles. For example, U.S. Pat. No. 6,787,033 to Beard et al.; U.S. Pat. No. 5,180,490 to Eihusen et al.; U.S. Pat. No. 7,410,572 to Beard et al.; U.S. Pat. No. 7,014,761 to Merritt et al.; U.S. Pat. No. 7,361,271 to Merritt et al. and U.S. 2009/0261029 to Fisher, show various bypass filter arrangement, the entire disclosures of these patent publications are all hereby incorporated by reference in their entireties. It is generally seen in these aforementioned references that typically, within a single housing, there is a single high efficiency pleated filter element and a single low efficiency pleated filter element. Relatively thin pleated filter sheet material is used in these applications.

Yet another type of filter media that is known is referred to as depth wherein fluid may pass through a substantial depth of filter media through which particulates may be deposited throughout the depth thereof. For example, a typical filter media layer thickness of depth media may be at least ¼ of an inch. Examples of such depth media, which are commonly sold under the trade designation PEACH, are illustrated and disclosed in U.S. Pat. No. 5,827,430 to Perry Jr. et al.; and/or U.S. 2008/0128364 to Cloud et al., the entire disclosures of which are hereby incorporated by reference in their entireties.

The invention is directed toward improvements over the state of the art.

### BRIEF SUMMARY OF THE INVENTION

A first inventive aspect of the present application is directed toward a filter cartridge that is especially configured for locomotive lubrication systems that comprises a pair of end caps with at least one of the end caps having an opening providing a fluid port. At least two filter elements are included, including a low efficiency filter element interposed between the end caps and a high efficiency filter element interposed between the end caps. The high efficiency filter element has a filter media of a higher efficiency than the low efficiency filter element. The filter cartridge is configured for a locomotive lubrication system wherein the filter cartridge has an axial length of at least about 18 inches.

Other features which may be provided in the above aspects that make the filter element particularly configured for some existing types or styles of locomotive lubrication system housings is that one of the end caps is a closed end cap and the other is an open end cap. Further, at least two seals may be carried by the open end cap in surrounding relation of a central opening in the open end cap. Each of the seals is adapted to seal against a housing having a stem pipe interface. For example, one seal may be an axial face seal to seal against the flap housing surface, while another seal may be a radial seal adapted to seal against the stem pipe of the housing. However, in some embodiments other housing arrangements for locomotives are possible.

Yet other features that are especially advantageous for locomotive oil lubrication systems, is that the filter cartridge may have an axial length of at least about 24 inches, and outer diameter of at least about 6 inches and an inner diameter (which can be measured by the opening in the open end cap) to facilitate attachment to a stem pipe of less than about 8 inches, but greater than about 3 inches. The filter cartridge has a strength characteristic of at least about 100 PSI fluid pressure.

In accordance with the above inventive aspect, preferably a flow divider is interposed between the end caps and divides a flow path through at least the high efficiency filter element. As a consequence, a first portion of the flow along the flow path passes through the high efficiency filter element and a second portion of flow along the flow path bypasses the high efficiency filter element. This may be advantageous where the high efficiency filter element is restrictive and serves to filter very small particles such as soot, for example. Preferably, the flow divider may take the form of a venturi tube. Either part or all of the fluid may pass through the low efficiency filter element in different embodiments.

Another inventive aspect of the present invention may go beyond locomotive lubrication systems and applications to filtration more generally, but also has particular advantage to such locomotive lubrication systems. According to this inventive aspect, a filter cartridge includes a low efficiency filter element (which may be a pleated element of relatively thin filter medium providing minimum restriction) in combination with a high efficiency depth media element. Filter cartridge, according to this aspect, includes a pair of end caps with at least one of the end caps having an opening providing a fluid port. A low efficiency filter element is interposed between the end caps. A high efficiency filter element is also interposed between the end caps. The high efficiency filter element has a filter media of a higher efficiency than the low efficiency filter element. The high efficiency filter element comprises a ring of depth media with a media thickness of at least ¼ and for trapping contaminants throughout the quarter inch depth thereof. At least a portion of the flow path through the filter cartridge bypasses the high efficiency filter element.

According to a further inventive aspect, the low efficiency filter element may have an efficiency rating for particular removal of greater than 10 micron. In contrast, the high efficiency filter element may have an efficiency rating for soot removal in locomotive lubrication systems that is less than 10 micron.

In some embodiments, the depth media may comprise at least five filter media layers wrapped successively around one another throughout the media thickness such that fluid typically has to pass through the at least five filter media layers. Further embodiments may include a grading media whereby the depth media gets more restrictive with smaller pore sizes towards the outlet side of the depth medium and is less restrictive with more open pore structure at the inlet side of the depth media surface. As a consequence, this can provide substantial depth and particulate holding capacity within the structure of the depth loading element throughout the depth of the media. This may also prevent premature clogging of the high efficiency filter element.

Typically, the depth media will have a media layer thickness of at least ¼ inch, more typically at least ½ inch and preferably at least 1 inch or more. In contrast, pleated filter sheet material will have a typical thickness of less than ⅛ of an inch.

Yet another inventive aspect of the present invention is directed toward a locomotive filtration system comprised of a housing defining a filtration chamber. The housing has an inlet and an outlet in communication with a lubrication circuit of a locomotive. A manifold has a plurality of fluid ports along the fluid chamber connected to one of the inlet and the outlet. A flow passage extends from the inlet through the filtration chamber and to the outlet. A plurality of low efficiency filter elements are arranged in parallel circuit with each other. Further, the plurality of high efficiency filter elements are provided. The high efficiency filter elements have a filter media of a higher efficiency than the low efficiency filter elements. The high efficiency filter elements are also arranged in parallel circuit with each other. The high efficiency filter elements and the low efficiency filter elements are also commonly mounted within the filtration chamber of the housing along the flow passage for filtering fluid flowing there along.

### BRIEF DESCRIPTION OF THE DRAWINGS

FIG. 1 is a partly schematic and cross sectional view of a plurality of filter cartridges in a locomotive oil lubrication system including a filter housing with the plurality of filter cartridges mounted therein having high efficiency and low efficiency filter elements;

FIG. 2 is a perspective view of one of the filter cartridges employed in the system of FIG. 1, with a partial cut away taken of the wrapper;

FIG. 3 is a partial cross section and cut away view of the filter cartridge shown in FIG. 2, with the low efficiency pleated medium not being illustrated in cross section;

FIG. 4 is a cross section of high efficiency filter element of the filter cartridge shown in FIG. 3 taken about line 4-4;

FIG. 5 is a cross section of the low efficiency filter element of the filter cartridge shown in FIG. 3 taken about line 5-5 (with the pleats being spread out a bit for better illustration purposes understanding that pleat packs are commonly more compacted than as illustrated);

FIG. 6 is an enlarged cross section illustration of an upper portion of a filter cartridge of FIG. 3 with a stem type mounting interface;

FIG. 7 is an isometric and partial cutaway view of a high efficiency depth type filter media having several wrapped layers which may be used for the high efficiency element of the filter cartridge of FIGS. 1-6;

FIGS. 8-10 illustrate various filter media examples of depth media usable for the high efficiency filter element for the filter cartridge of FIG. 3, the examples being shown in cross section and partly schematic form for purposes of demonstration; and

FIGS. 11A-11D illustrate scanning electron microscopic (SEM) images of a particular advantageous fiber structure of the depth media according to an embodiment of the present invention which employs a combination of fine fibers having an average diameter of less than one micron and typically less than 500 nanometers in combination with course fiber support having an average thickness of greater than three micron.

FIGS. 12A-12C are cross-sectional illustrations of a filter cartridge according to a second embodiment of the present invention that is similar to that of the first embodiment shown in FIG. 3 and also usable with the locomotive filtration system 110 and housing 112 of FIG. 1, but in accordance with a second embodiment of the present invention, with FIGS. 12B and 12C being enlarged views of a portion of the cross section of FIG. 12A.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

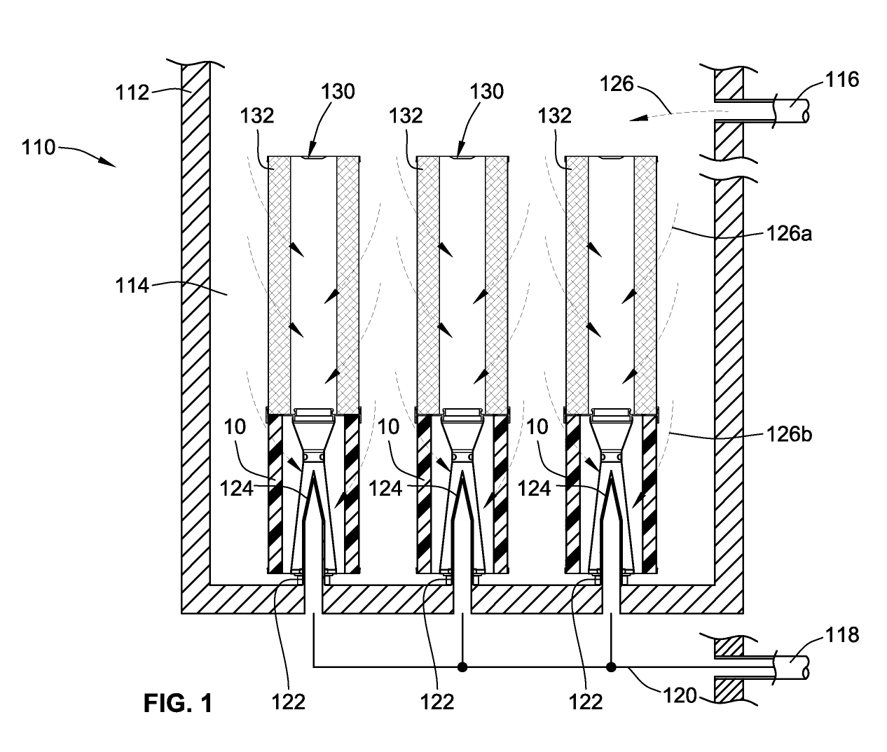

Turning to FIG. 1, an embodiment of the present invention has been illustrated in the form of a locomotive filtration system 110 disposed along a lubrication circuit of a locomotive engine for filtering particulates and soot from of lubricating oil. The system 110 generally includes a housing 112 defining an internal filtration chamber 114. Connected to the filtration chamber 114 are a lubricating oil inlet 116 and a lubricating oil outlet 118. The outlet 118 is connected to the filtration chamber via a manifold 120 and through a plurality of stem pipes 122 that project in an array from the housing into the filtration chamber 114. The stem pipes 122 may have tapered ends 124 to facilitate or guide in the mounting of filter cartridges 130.

As can be seen in FIG. 1, the locomotive filtration system employs several filter cartridges that are commonly mounted within the same filtration chamber 114, with each filter cartridge being mounted over one of the stem pipes 122. As is schematically illustrated in FIG. 1, a flow path and pass 126 extends from the inlet 116 into the filtration chamber 114, through the filter cartridges 130, thereafter, the stem pipes 122 to the manifold 120 and then to the outlet 118.

Each filter cartridge 130 employs a low efficiency filter element 132 and a high efficiency filter element 10. In the system 110 shown in FIG. 1, it can be seen that the high efficiency elements 10 are each arranged in parallel circuit with each other. Further, the low efficiency filter elements 132 are also arranged in parallel circuit with each other as well. The low efficiency filter elements 132 may have an efficiency rating of at least about 10 micron suitable for filtering larger particulates from the oil lubrication flow. In contrast, the high efficiency filter elements have an efficiency rating of less than 10 micron and preferably, less than about 5 micron suitable for filtering soot, which may be experienced and produced by a locomotive lubrication system during the operation of a diesel engine thereof. Preferably, the low efficiency filter element has a higher efficiency than 30 micron filter elements of the prior art, and may be between 10 and 20 micron; 12 micron rating being an example.

Herein, filtration efficiency means initial efficiency at typical system operation (e.g. a flow rate of at least 45 gallons per minute (GPM) through an individual cartridge; and a pressure of 100 PSI) with at least 90% particle removal. Typically, the pressure drop across the filter cartridge will be 1 to 3 PSI and more typically between 1 and 2.

The housing 112 includes an access port or cover (not shown) which facilitates access to each of the filter cartridges 130. Thereby, each of the filter cartridges 130 can readily be installed and removed through the top open end of the housing 112. In these applications, the filter cartridges typically have a length of at least 18 inches and typically, more than about 24 inches (sometimes even more than 40 inches). As can be appreciated, this can require blind mounting of filter cartridges into the housing 112, where the mechanic has to attempt to locate and push the filter cartridge onto a stem pipe without necessarily seeing the stem pipe.

By utilizing a combination of a low efficiency filter element in combination with a high efficiency filter element, a high flow rate can be achieved and while at the same time capturing a significant quantity of smaller micron particles such as soot. Thus, the present embodiment does not sacrifice the lubricated oil flow to the lubricating system of the locomotive due the open pore structure and high flow rate capacity permitted by the low efficiency filter element 132. In contrast, the high efficiency filter element has a tighter pore structure and is arranged along a divided flow path with a bypass to receive only a portion of the flow.

The low efficiency filter element may either receive full flow (as may be described in later embodiments) or a partial flow, but typically the high efficiency filter element, with a more restrictive media, will only receive a small portion of the flow to gradually limit or otherwise reduce the amount of soot being experienced in the lubricating oil flow. Therefore, as can be seen schematically with the flow path shown for 126, there is a portion 126a of the flow path that goes through the low efficiency filter element and not the high efficiency filter element; and a portion of the flow path that goes through the high efficiency filter element 126b. The filter cartridges are configured and constructed to withstand the pressure loads experienced in oil lubricating circuits of locomotives and typically have a strength characteristic of at least about 100 PSI fluid pressure, as may be experienced in such locomotive lubrication systems.

Preferably, the low efficiency filter element is comprised of a relatively open, but thin, filter media 134 comprising, for example, a pleated filter media 134 of cellulose filter paper that may have a complete layer thickness of less than ⅛ of an inch, and typically between 20 Mils and 60 Mils. Further, by pleating the media into a tubular ring, or otherwise bunching up the media, a substantial surface area upon which fluid can enter is provided. Thus, this provides for a very high flow capacity through the low efficiency filter media 134. Further, this provides the benefit of removing the large particles that could readily cause wear to components of a locomotive engine.

In contrast, the high efficiency filter element 10 is configured for removing very tiny particulates such as soot, which have a particle size typically less than 10 micron, and more often, less than 5 micron. To provide for a substantial holding capacity and considering that flow rate through the high efficiency filter element is not as critical, preferably a very thick depth loading media is utilized for the high efficiency filter element 10. However, the high efficiency filter element could also comprise a much higher efficient, but thin, pleated filter medium such as may be provided by synthetic medias such as micro-glass, melt blown materials or other synthetics or blends as may be appropriate in other embodiments.

Typically, less than 50% of the fluid flow will pass through the high efficiency filter element; and more typically less than 25%. At least 50% of the fluid flow will pass through the low efficiency filter element and in some cases 100% (wherein the low efficiency is a full flow element in series with the high efficiency element and a bypass that are in parallel).

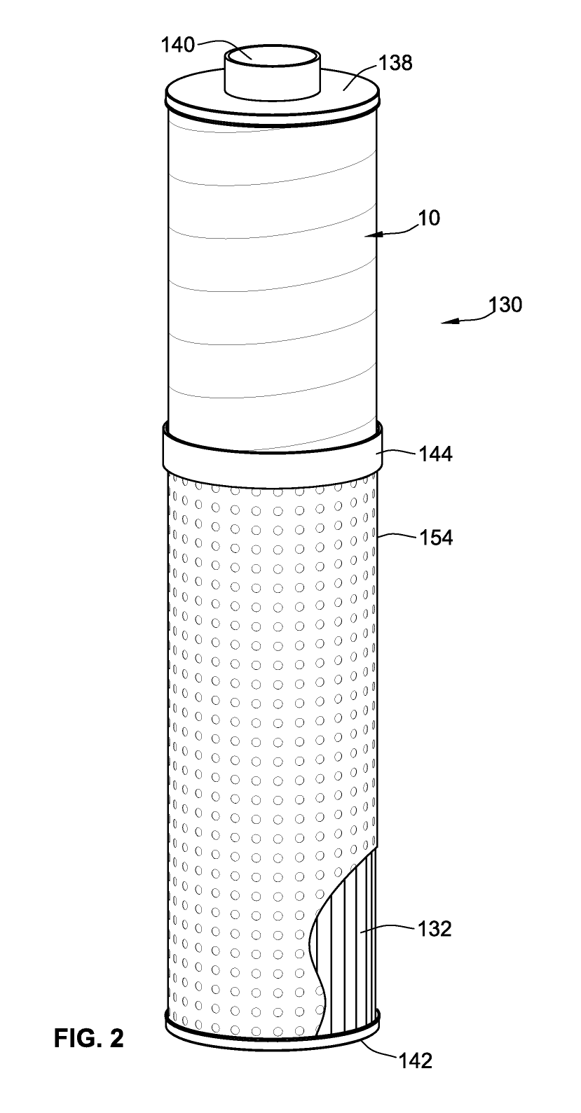

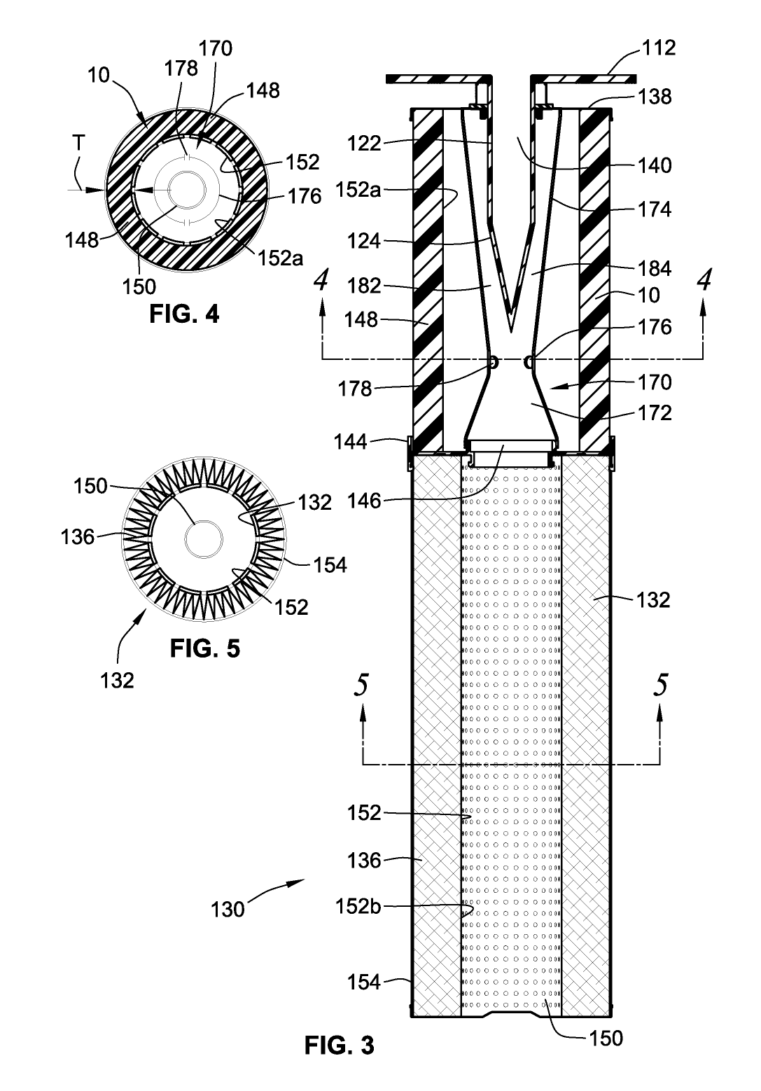

According to one embodiment of the filter cartridge, a stacked filter element design is shown, for example, in FIGS. 2-6, each of which are configured for locomotive lubrication applications. With reference to FIGS. 2-6, it can be seen that each filter cartridge 130 includes an open end cap 138 having a central opening 140 and a closed end cap 142 at the opposite end of the filter cartridge. Interposed between the end caps 138, 142 are the low efficiency filter elements 132 and the high efficiency filter element 10. As can be seen, these filter elements are arranged in axially end to end and generally coaxial relation (so as to surround a hollow core). Respective tubular rings 136,148 of each element are in generally surrounding relation of the central opening 140.

To facilitate the stack design, a divider end cap 144 also having a central opening 146 is interposed at the opposed axial ends of the tubular ring 136 of the low efficiency filter element 132 and the tubular ring 148 of the high efficiency filter element 10. Each of the end caps 138, 142 and 144 can be sealingly bonded along a circular interface to respective ends of the filter elements with such means as heat bonding or urethane adhesive if the end caps are plastic or in the case of metal end caps, the potting compound such as plastisol or adhesive. Further, in the case of plastic end caps, the media may also be thermally welded or embedded directly into the structure of the end cap to provide a seal bond.

With the structure described, it can therefore be seen that a hollow core 150 is defined within the central area of the filter element extending the axial length of the filter elements to the central opening 140 of the open end cap, which thereby provides a fluid outlet port for returning clean lubricating oil to the oil lubrication circuit. To provide for support of the tubular rings of filter media, preferably there is provided an inner perforated core 152 which may extend the full axial length of the filter cartridge and which may also be divided into separate sections 152a, 152b as shown, by the divider end cap. Considering that fluid flow is radially from the outside in, the perforated core, which may be either a solid plastic tube structure or a perforated metal structure (e.g. expanded wire mesh or perforated metal sheet) provides radial support to the filter medias to support the filter medias against the inward radially flow of fluid therethrough and higher pressure on the outside of the filter cartridge. It may be possible to eliminate the perforated core 152a for the high efficiency filter element, seeing that this filter media is generally self supporting in an embodiment.

Additionally, it should be noted that these filter elements are preferably not arranged in their own housings so that the filter cartridges can be arranged in multiple and parallel circuit with each other in a single common housing, as shown earlier with reference to FIG. 1. To provide for protection in such an application, an outer perforated wrapper 154 such as expanded wire mesh or hole punched shape material (either metal, cellulose paper or plastic) is wrapped around at least the low efficiency filter media 134 in extension and interposed between the opposed end caps 138, 142. This outer perforated wrapper 154, thereby protects the integrity and prevents damage to the relatively thin filter media of the pleat filter element, that being the low efficiency filter element 132 in this embodiment.

However, the outer perforated wrapper 154 may extend the full axially length of the filter element and also extend over the high efficiency element 10, which would also be preferred if the high efficiency filter element is made of pleated material as well. However, in the case of a thick depth media, it is a more sturdy and sound structure having substantial depth that is not easily punctured, such that the wrapper need not extend over the high efficiency filter element 10 when provided by a tubular ring of thick depth media. This is shown in FIG. 2 for example. The high efficiency may also utilize a cotton string, wound around and adhered to the media I.L.O. the perforated wrapper.

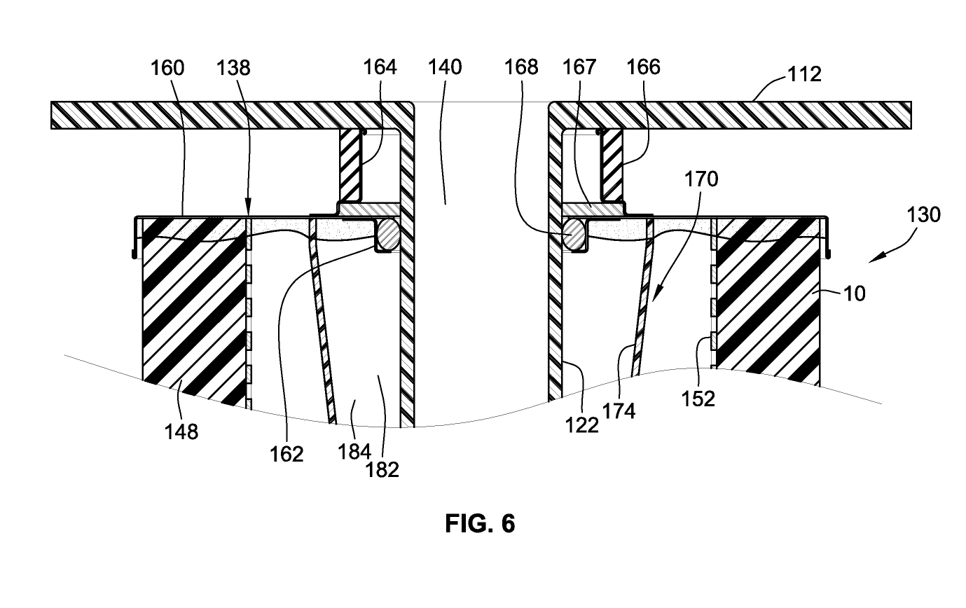

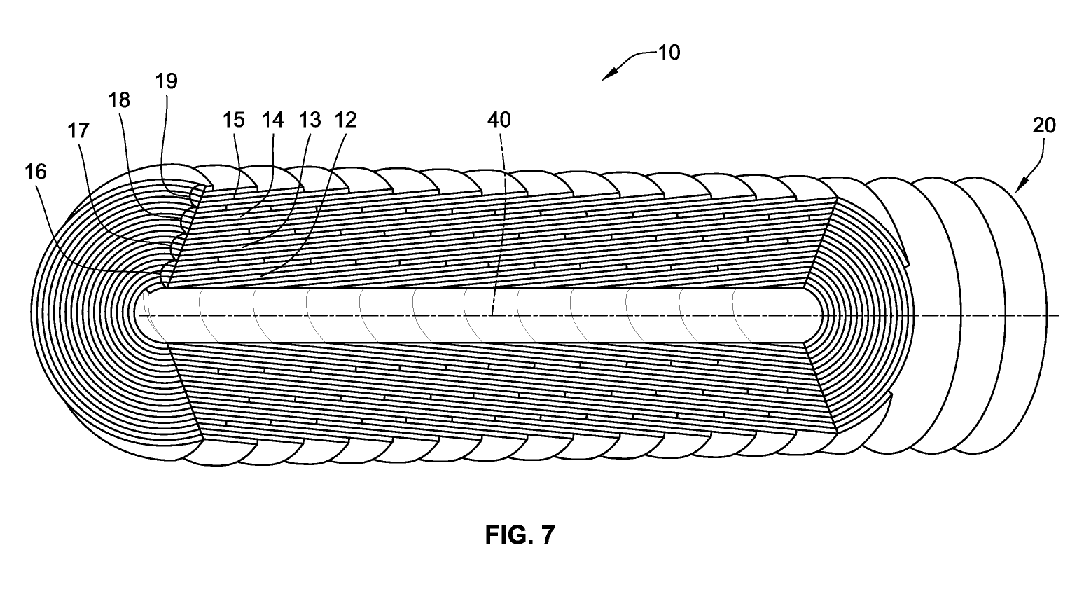

Turning to the configuration of the open end cap 138 and with reference to the enlarged FIG. 6, it is seen that the open end cap 138 may be an assembly of a couple different components to provide for a mounting interface to a relatively common stem pipe configuration experienced in lubrication circuits. For example, the open end cap 138 may include an annular end cap disc 160, an inner seal retainer 162, and an outer seal retainer 164. These structures facilitate and hold at least two and more preferably three seals 166, 167, 168 for sealing against the housing and stem pipe of the lubricating circuit of the locomotive. For example, seal 166 provides an axial face seal against the flat housing surface, while seals 167 and 168 each provide redundant back up seals for radial sealing against the stem pipe when installed thereon. Some application may only utilize seals 167 and 168 while omitting the use of seal 166. In this instance, the retainer 164 will seat direct against the flat housing. This configuration may generally be in accordance with U.S. Pat Pub. 2010/0051528 to Derstler et al., the entire disclosure which has been incorporated by reference in its entirety.

To facilitate a flow division and bypass around the high efficiency filter element, a flow divider is also interposed between the end cap 138, 142 and internal to inner perforated core 152, which may take the form of a venturi tube 170. In this embodiment, the venture tube 170 is situated within the hollow core 150 of at least the high efficiency element 10. The venturi tube 170, for example, might extend simply between the open end cap 138 and the closed end cap 142 with opposed ends being sealed potentially in sealing relationship with internal surfaces of the opposed end caps, such as being embedded within potting compound or adhesive, which also happens to secure the ends of the filter media to the end cap structures. The venturi tube includes a narrowing inlet section 172, and a widening outlet section 174, which are connected by an intermediate central restriction 176. At the central restriction 176, flow openings 178 can be provided to receive flow from the high efficiency filter element 10, which merges into the flow path coming from the hollow core 150 (e.g. the more massive flow that has passed through the low efficiency filter element 132). By positioning flow openings 178 proximate the central restriction 176, a suctioning effect is created due to pressure differential via the venturi effect to help suction flow through the more restrictive high efficiency filter element.

Therefore, once mounted, the filter cartridge 130 is thereby mounted in parallel circuit with other filter cartridges 130 so that flow entering can pass through any of the filter cartridges to reach the outlet. With this arrangement, several low efficiency filter elements 132 are thereby placed in parallel circuit with each other as well as high efficiency filter elements 10 also being placed in parallel circuit with each other. Further, in each filter cartridge in this embodiment, the low efficiency filter element is placed in parallel circuit with the high efficiency filter element. During operation, much of the flow, typically at least 50%, will pass through less restrictive low efficiency filter element 132 with at least a portion of the flow passing through the high efficiency filter element. Thus, a portion of the flow, thereby, bypasses the high efficiency filter element and goes only through the flow efficiency filter element. This bypass flow may also help to suction through the venturi effect and pressure deferential fluid through the high efficiency filter element, where it is then rejoined and can exit the filter cartridge through the stem pipe 122.

In this embodiment, that the widening outlet section 174 of the venturi tube or in a broader sense, the flow divider, is positioned proximate the outlet end of the filter cartridge and is positioned and configured to form a receiving chamber 182 for the tapered end 124 of the stem pipe 122 (not all stem pipes are necessarily tapered), providing an annular clearance 184 between the stem pipe 122 and the widening outlet section 174 of the venturi tube 170. Thus, the venturi tube is configured to a common the stem pipe 122 and also ranged to be large enough so that the widening outlet section 174 is appropriately sized to effect the venture effect and pressure differential for drawing fluid through the flow openings 178. In other words, the stem pipe when received therein, in combination, creates or facilitates the venturi effect and also leads to an exit port that is internal to the high efficiency filter element itself, through openings in the stem pipe. The venturi tube therefore accommodates and interacts with a typical stem pipe mounting configuration of locomotive applications.

In certain embodiments, the high efficiency element 10 may be a pleated filter media ring similar to the low efficiency filter element but constructed and pleated from a synthetic filter media sheet such as micro-glass, meltblown polymeric media, pleated nanomatrix, other synthetic and/or blends thereof with cellulose to provide an efficiency rating of less than 10 micron (preferably less than 5 micron), suitable for removing soot in locomotive lubricating oil systems (under pressure loads experienced therein)—typically at least 90% of soot removal at the selected micron rating. These medias will tend to have a substantial amount of surface area to allow fluid flow and may be surface filtration. Certain embodiments, such as illustrated embodiments of FIGS. 1-6, employ a high efficiency filter element 10 that is a thick non-pleated ring of depth loading media comprised of multiple layers of filter media of at least about ¼ inch thick, typically at least ½ inch thick, and often 1 inch thick or more to provide a substantial amount of media through which fluid must pass. This thick layering also provides a substantial holding capacity for soot, and may be configured with a gradient pore density with pore size decreasing in size generally from the inlet side to the outlet side. One preferred form is PEACH filter media available from Perry Equipment Company of Mineral Wells Texas, which embodiment is below described in detail.

Examples of PEACH filter media or other depth medias that may be usable in embodiments (including meltblown depositions and non-helical spiral wraps), can be found in U.S. patent application Ser. No. 61/383,569 to Green et al. (filed Sep. 16, 2010), the entire disclosure of which is hereby incorporated by reference. These medias may include fine fibers such as nanofibers (fibers often having a thickness of less than 500 micron) to cut up and reduce pore sizes to catch smaller particles without imposing restriction or blockage to fluid flow due to the small volume and area occupied by such fine fibers. However, more conventional PEACH medias such as disclosed in U.S. Pat. No. 5,827,430 and U.S. Publication Number 2008/0128364, may also be employed or other non-fine fiber medias, and as such the entire disclosures of these other patent references have been incorporated by reference in their entireties.

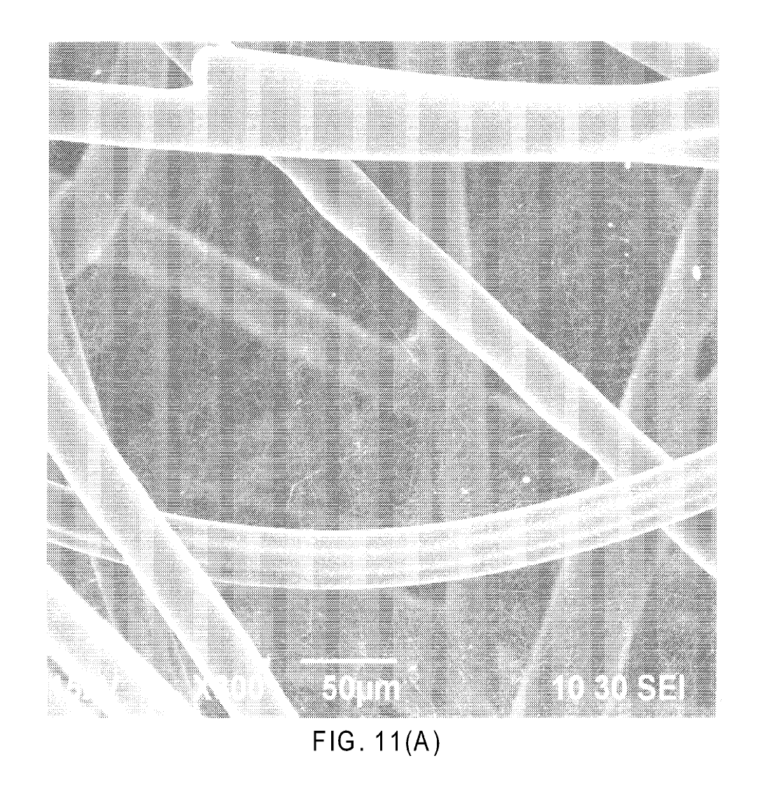

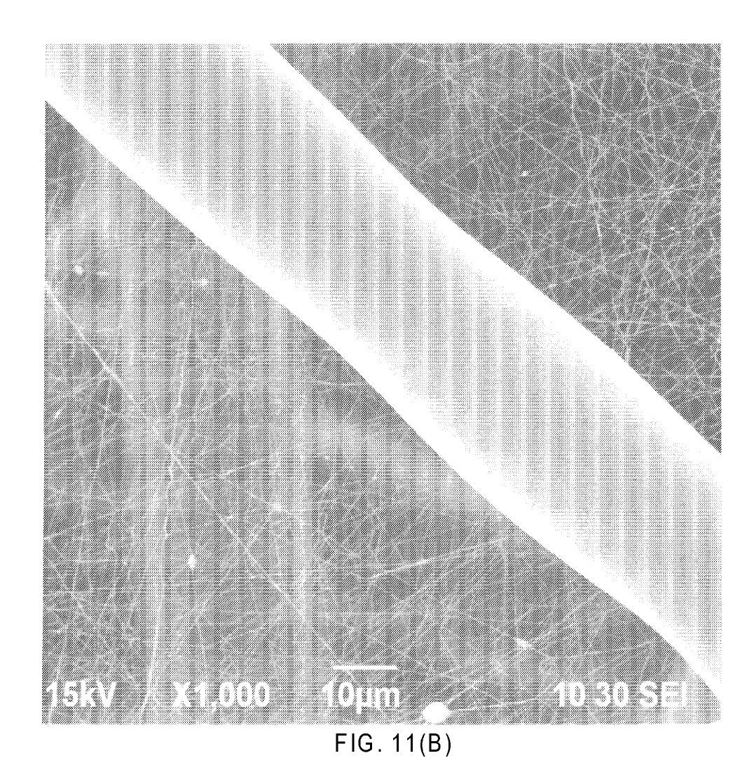

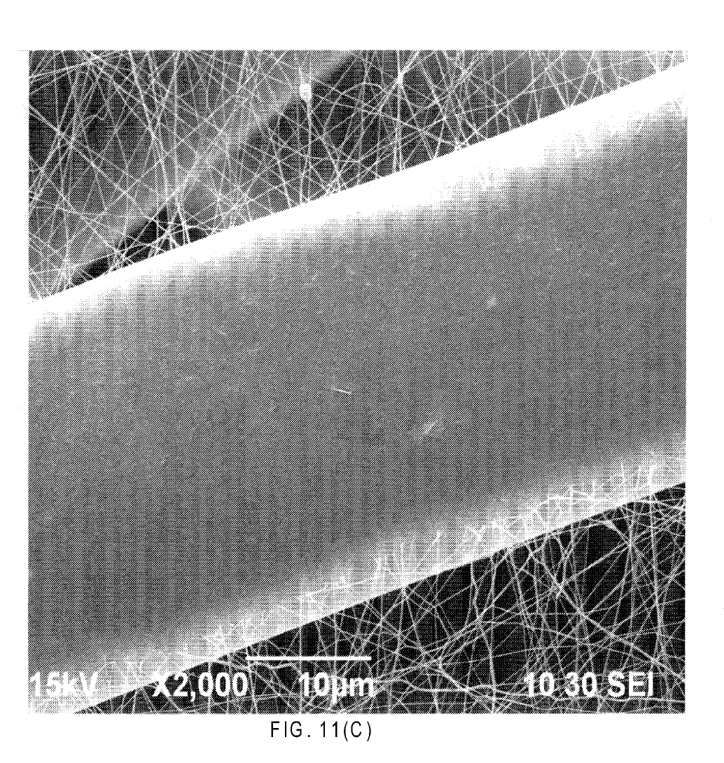

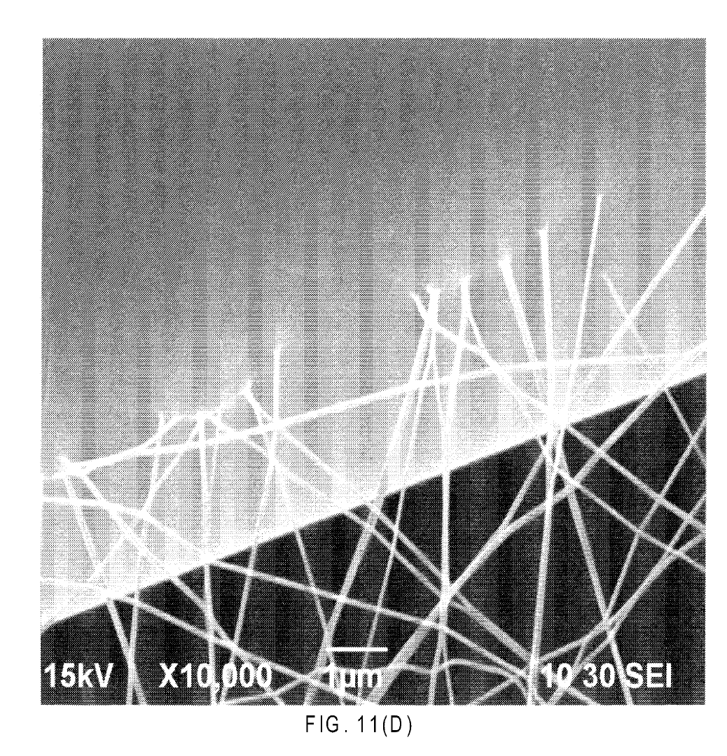

Referring to FIG. 7 of the drawings, a multi-overlapped coreless filter element 10 is illustrated and constructed according to a PEACH process and an embodiment of the invention. As will be described herein, the filter element 10 has integrated therein a combination of fibers including carrier fibers having an average size greater than about 3 micron; and on the other hand fine fibers having a size of less than about 800 nanometer (more preferably less than 500 nanometer, even more preferably less than 250 nanometer and most preferably less than 100 nanometer). To help visualize the difference between fiber sizes and illustrate how the finer fibers reduce pore size without occupying much area or volume, FIGS. 11A-11D are provided.

Turning to FIG. 7 again examples of a gradient wound depth media employing fine fibers on at least some of the layers is described. The filter element 10 includes a first multi-overlapped nonwoven fabric strip 12, a second multi-overlapped nonwoven fabric strip 13, a third multi-overlapped nonwoven fabric strip 14, and a fourth multi-overlapped nonwoven fabric strip 15. As used herein, a strip will sometimes be referred to as a sheet and vice versa. In this instance, a partial width strip is provided (partial width relative to the axial length of the filter element), so that each strip can be helically wound in this embodiment. Each fabric strip 12-15 is spirally or helically wound in overlapping layers to form overlapping bands 16, 17, 18, 19, respectively. Collectively, these bands form a non-pleated tubular ring 20 of a depth media having a total media thickness T of at least about ¼ centimeter.

The radially interior surface of the innermost band 16 forms the periphery of an axially extending annular space (that may be used to collect clean fluid and facilitate axial flow of cleaned fluid). This hollow interior space extends from one end of the filter element to the oppositely facing end of the filter element 10. In the drawings, the thickness of the fabric (as well as fine fiber layers where illustrated) is exaggerated for purposes of demonstration. However, the tubular ring of depth media typically has at least ¼ cm in thickness (radial thickness) and more typically between ½ cm and 5 cm (more typically between 1 cm and 3 cm) of thickness as a consequence of the wraps. It can be seen that each strip 12-15 at least partially overlaps itself once to make the given band thick at a range of generally between 2-8 wraps thick for one of the given fabric strips. Additionally similar embodiments of the filter element 10 employ at least 1 fabric strip thick, and more typically, between 2-6 fabric strips. As such, and due to overlapping of each strip upon itself, filter elements can be made employing the helical wrapping technique of between 2 and 48 layers thick (most typically between 6 and 32 layers thick).

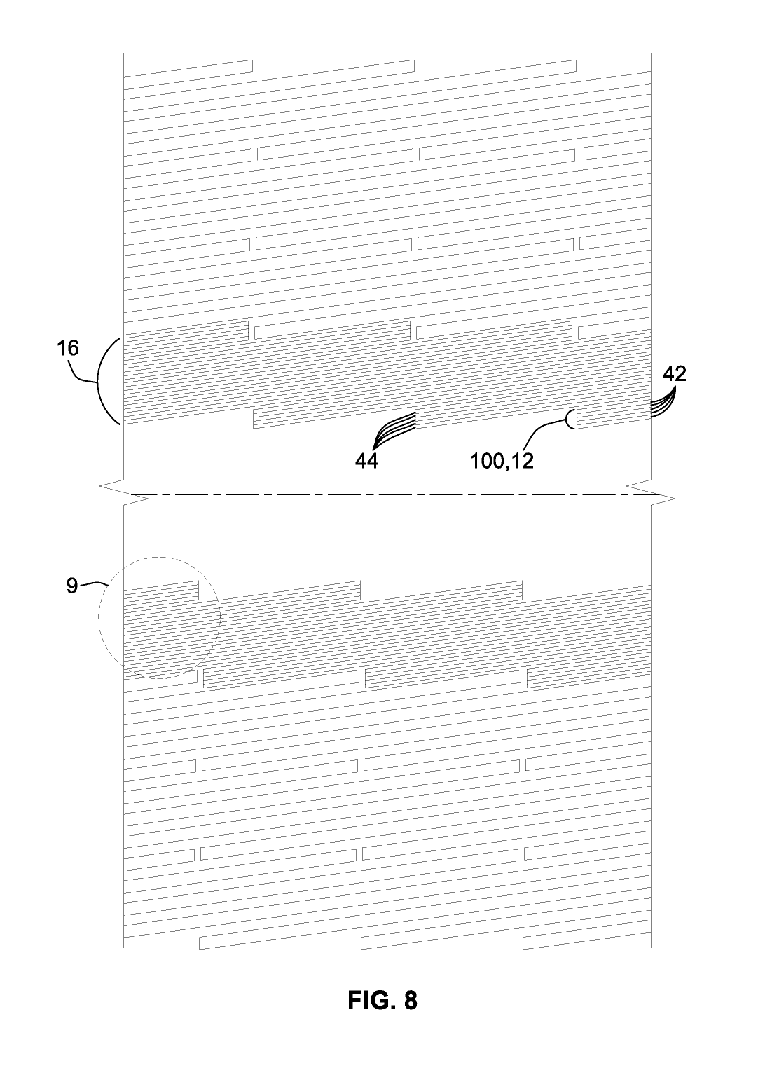

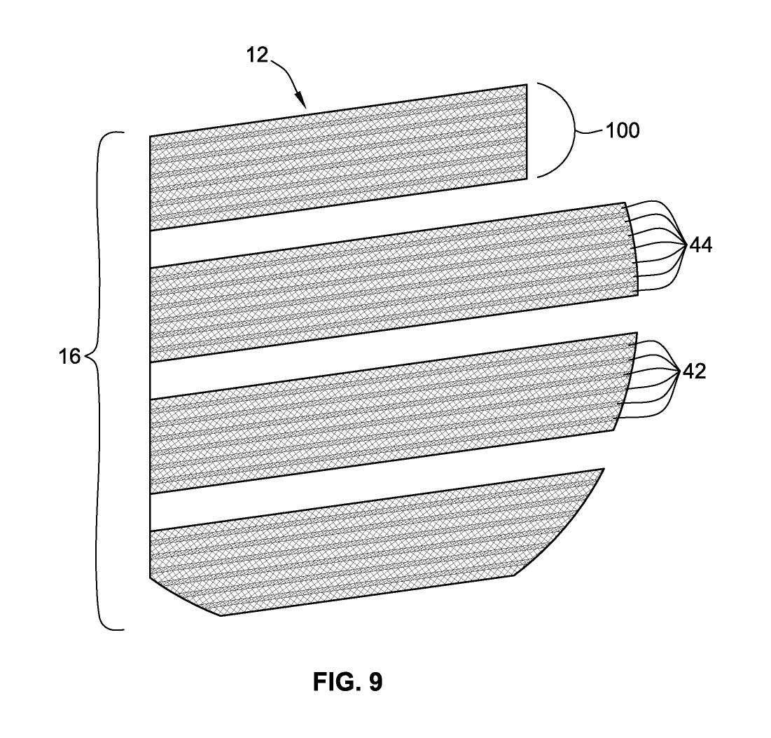

In this embodiment of FIG. 7, and with additional reference to FIGS. 8 and 9, a preformed multiple laminated layer filter media sheet 100 is selected and employed for use as the innermost fabric strip 13. In another embodiment, the multiple layer filter media sheet 100 is selected and employed for use as the second innermost fabric strip 14 as well as the innermost fabric strip 13. In contrast, the upstream fabric strips 15, 16 may employ no fine fibers but a more open structure to create a gradient media throughout the entire thickness T.

For example, the upstream non-woven fabric strips 15, 16 may be composed of selected polymeric fibers such as polyester and polypropylene, which serve as both base fibers and binder fibers. Base fibers have higher melting points than binder fibers, which is also referred to herein as bi-component media or multi-component media. The role of base fibers is to produce small pore structures in the coreless filter element 11. The role of the binder fiber or binder material is to bond the base fibers into a rigid filter element that does not require a separate core. The binder fibers may consist of a pure fiber or of one having a lower melting point outer shell and a higher melting point inner core. If the binder fiber is of the pure type, then it will liquefy throughout in the presence of sufficient heat. If the binder fiber has an outer shell and an inner core, then it is subjected to temperatures that liquefy only the outer shell in the presence of heat, leaving the inner core to assist the base fiber in producing small pore structures. The role, therefore, of the binder fiber is to liquefy either in whole or in part in the presence of heat, the liquid fraction thereof to wick onto the base fibers to form a bond point between the base fibers, thereby bonding the base fibers together upon cooling. The binder material may be in a form other than fibrous.

While a gradient depth media is embodied in FIG. 7 with the multiple layer filter media sheet 100, it is envisioned that the multiple layer filter media sheet 100 may be employed at different locations upstream or downstream locations and may be selected for use for any one or more of the strips 12-15.

An embodiment of a method and apparatus for making such a filter element 10 can be had in accordance with the disclosures of U.S. Pat. No. 5,827,430 to Perry, Jr. et al.; and/or U.S. 2008/0128364 to Cloud et al., the entire disclosures of each of which are hereby incorporated by reference in their entireties.

Turning now to FIGS. 8 and 9, it can be seen that the resulting arrangement of the helical wrap presents a unique structure and arrangement by virtue of the multiple layer lamination of the multi-layer filter sheet 100. While further details of such a sheet 100 will be discussed later on, it will be appreciated that multi-layer filter sheet 100 provides flow structure within the individual strip 12 that employs the filter sheet 100. In particular, with the helical wrap arrangement, the strips are canted relative to the longitudinal axis 40 of the filter element 10. As a consequence, the individual fine fiber layers 42 are arranged at a canted alignment and non-parallel to the axis 40 such that fluid can flow through the sheet 12 along individual fine fiber layers. In particular, the more open and porous substrate 44 are also arranged at a canted alignment and non-parallel to the axis 40; and thereby may act as a drainage layer or fluid flow layer within the strip 12.

Accordingly, there may be canted microflow paths through the strip 12 through the more open and porous substrate layers 44. Particulates can be trapped during this process by the more efficient fine fiber layers 42. Additionally, between adjacent wraps of the strip 12, there may also be flow across and between the strips, which may be referred to as macroflow paths between strips, even though in practice adjacent wraps of a strip are in contact and touching. In addition to the potential for flow along canted microflow or macroflow paths, a significant amount of flow is also radially through the material of the strip itself passing through successive fine fiber and substrate layers 44, 42 wherein particulates can be trapped. However, it should be appreciated that should the fine fiber layer 42 clog with particulate, there is an open canted flow path through the strip along the porous substrate layers 44. As a consequence and while many filters will tend to improve efficiency over time, it may be that the present arrangement may eventually decrease in efficiency over time as particulate loading causes more flow along the canted flow paths through the substrate layers 44 as opposed to radially through the media (and fine fiber layers 42).

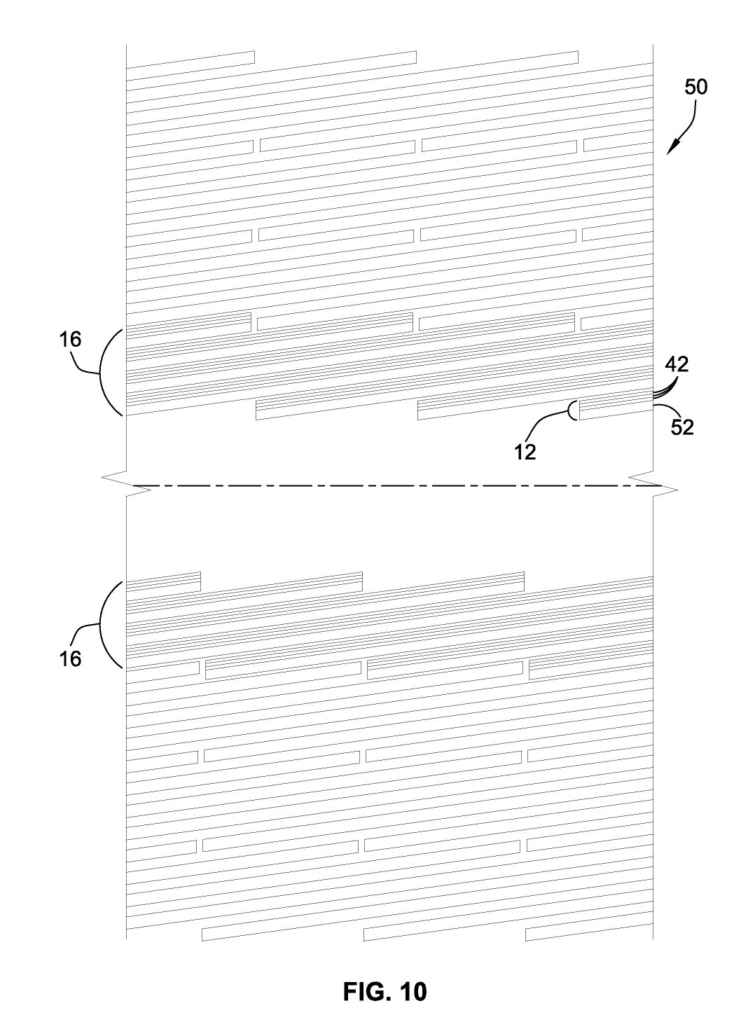

Turning now to FIG. 10, a filter element 50 yet another embodiment is schematically illustrated in cross section. The filter element 50 is a similarly helically wrapped filter element to the first embodiment and as such, similar reference numbers are used, but additionally employs an interlay strip 52 that overlays the strip 12 employing the multi-layer filter sheet 100 (see FIG. 9) with fine fiber layers 42. The arrangement and variations of an interlay may also be in accordance with any of the examples of U.S. Patent Publication No. 2008/0128364 to Cloud et al., which has been previously incorporated by reference. While a single band in this embodiment is shown to have an interlay, multiple bands 16-19 (such as in first embodiment shown in FIG. 1) may employ an interlay. One or more of these bands may include at least one of the strips as having fine fibers (the interlay may also optionally include fine fibers).

In this embodiment, a lower efficiency interlay strip 52 is wrapped along with the strip 12 employing the multi-layer filter sheet 100. Typically, in this arrangement, one of the strips will have a greater flow porosity and the other strip a greater efficiency and less porous structure resulting in greater flow horizontally/diagonally. As a consequence, more flow in this embodiment may be along the canted path through the interlay strip 52 as compared with the efficiency strip 12 employing the multi-layer filter sheet 100.

Incorporating fine fibers onto filter media sheets can be had in accordance with U.S. patent application Ser. No. 61/383,569 to Green et al (filed Sep. 16, 2010). Additionally, filter media including fine fibers formed using an electrostatic spinning process is also known. Such prior art includes Filter Material Construction and Method, U.S. Pat. No. 5,672,399; Cellulosic/Polyamide Composite, U.S. Patent Publication No. 2007/0163217; Filtration Medias, Fine Fibers Under 100 Nanometers, And Methods, U.S. Patent Publication No. 2009/0199717; Integrated Nanofiber Filter Media, U.S. Patent Publication No. 2009/0266759; Filter Media Having Bi-Component Nanofiber Layer, U.S. Provisional patent application No. 61,047,455; Expanded Composite Filter Media Including Nanofiber Matrix and Method, U.S. provisional patent application No. 61/308,488; and Compressed Nanofiber Composite Media, U.S. provisional patent application No. 61/330,462, the entire disclosures of which are incorporated herein by reference thereto.

One particular sheet useful in winding embodiments is a multilayer composite. The first filter media sheet can comprises a composite media of a plurality of scrim layers and a plurality of fine fiber layers of fine fibers laminated together in the first filter media sheet. Selected fine fiber layers are spaced apart and separated within the first filter media sheet by the scrim. The filter media sheet itself can have a high coverage level of electrospun fine fibers having an average size of less than 500 nanometers of at least about 5,000 km/m², and preferably higher according to various embodiments.

Based on testing, the fine fiber filter depth composite media has a filtration efficiency substantially comparable to or better than micro-glass filtration media for a preselected filtration application. Thus, it may serve as a substitute for micro-glass filter medias and thereby avoiding a need for micro-glass entirely from a filtration structure while at the same time providing a high efficiency with suitable application flow/lifespan requirements.

Another preferred feature is the provision of a high lineal coverage of nanofibers in terms of kilometers per square meter can be accomplished both in an individual wrap or sheet or collectively throughout the depth of the element (with square meters being measure at average diameter). For example, the depth media may have a coverage of fine fibers carried throughout the depth of at least 0.1 gram/m², and at least about 10,000 km/m²; more preferably a coverage of fine fibers carried throughout the depth of at least 0.5 grams/m², and at least about 50,000 km/m²; and most preferably a coverage of fine fibers carried throughout the depth of at least 1.0 grams/m², and at least about 100,000 km/m².

According to another inventive aspect that may incorporate the above features, a filter element comprises a non-pleated tubular ring of a depth media having a media thickness of at least about ¼ centimeter. The depth media comprises carrier fibers and fine fibers, the carrier fibers having an average size of at least about 3 micron; and the fine fibers having an average size of less than 800 nanometers carried by the carrier fibers.

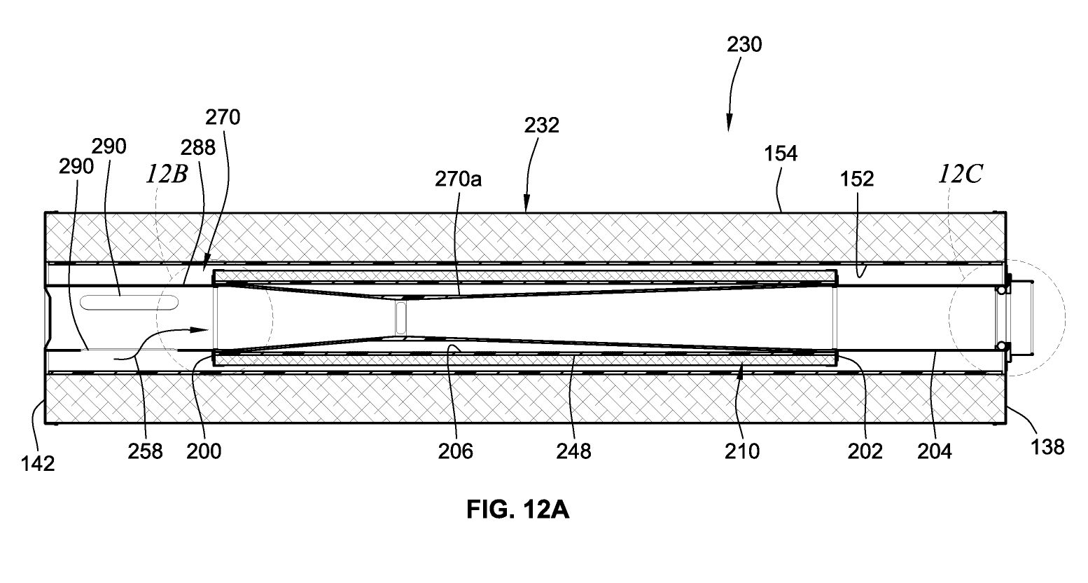

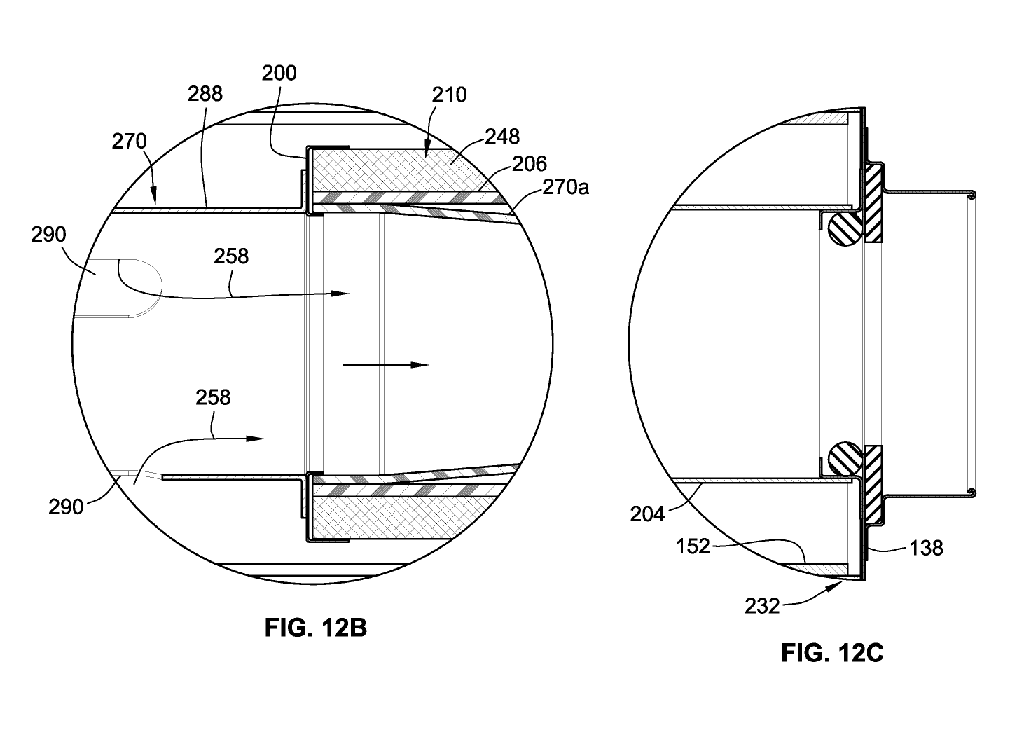

Turning now to FIGS. 12A-12C a second embodiment of the present invention is illustrated in the form of a filter cartridge 230 having a 100 percent flow or full pass low efficiency filter element 232 in combination and in series with a partial flow high efficiency filter element 210. As can be readily seen it these Figures, the filter cartridge 230 of the second embodiment is interchangeable and can be readily used and installed on the stem pipes 122 of the housing 112 shown in FIG. 1. As cartridge 230 also employs the same end caps structures and snout configuration with seals for this locomotive filtration system sealing interface. Similarly, the second embodiment also has the same or similar filtration range parameters as that of the first embodiment, both in terms of size and as well as relative efficiencies for the different elements, and portion of flow that may pass or bypass the high efficiency filter element. As such, only some differences will be highlighted between the embodiments.

Most notably, in this embodiment as opposed to a stacked design of the first embodiment, one filter element namely the high efficiency filter element 210 is concentrically arranged and surrounded by the low efficiency filter element 232. In this manner, all fluid must first pass through the low efficiency filter element 232 and then can pass in series through the high efficiency filter element 210. As a consequence, large particles are not prone to plugging prematurely the high efficiency filter element 210, which can focus only on filtering the smaller particles.

For example, the low efficiency filter element may have an efficiency greater than 10 such as a 12 micron rating and the high efficiency filter element may have below a 5 micron rating such as a 1 micron rating. As noted, in this embodiment, 100 percent of the flow passes first through the low efficiency filter element and thereby can be deemed 100 percent flow or full pass type low efficiency filter element. Alternatively, 100% may not pass through the element, as a partial percentage may be bypassed through venturi (either filtered or unfiltered).

There is also a bypass 288 arranged in parallel circuit with the high efficiency filter element 210 that allows for fluid to bypass the high efficiency filter element. Therefore, high flow ratings can be achieved and sufficient flow is not impeded by virtue of the addition of the high efficiency filter element which may filter only a fraction of the flow at any time, but over time will filter and reduce finer particulates from the recirculated fluid flow.

The bypass 258 is provided by a flow divider, which may comprise a venturi tube assembly 270 that includes a bypass cylinder 288 with bypass flow ports 290 to provide for the flow bypass 258 and flow path around the high efficiency filter element 210. In this embodiment, the bypass cylinder 280 is on one end of the high efficiency filter element and also serves to support and locate a first open end cap 200 of the high efficiency filter element 210. A central flow path is thereby formed through the venturi tube assembly 270 with a venturi tube portion 270 (it is similar with the same sections and flow openings as venturi tube 170 of the first embodiment) extending between the first open end cap 200 of the high efficiency filter element, and a second open end cap 202 thereof. A solid cylindrical flow pipe 204 serves to space and coaxially locate the second open end cap 202 relative to the other end of the filter element.

In this embodiment, the high efficiency filter element 210 includes a pleated high efficiency filter media ring 248 that is supported by a perforated support tube 206 that lines the inside perimeter thereof. The perforated support tube 206 as well as opposed ends of the high efficiency filter ring 248 can be potted and otherwise sealingly bonded to opposed first and second open end caps 200, 202 along annular interfaces therebetween.

While pleated filter media is shown being used in the high efficiency filter media of high efficiency filter element 210, it is also understood that similar to the first embodiment that a PEACH type depth filter tube or other depth media could also be interchangeably used in this embodiment, including medias which may include fine fibers having a diameter thickness of less than 500 nanometers.

With this arrangement, 100 percent of the fluid flow will first pass through the low efficiency filter element and then be divided by the flow divider in the form of venturi tube assembly 270, with a first portion flowing along the bypass 258 and a second portion flowing through the high efficiency filter element 210. These flows are rejoined within the central flow passage contained within venturi tube portion 278. Thereafter, this rejoined fluid can then exit the filter through the open end cap and seal interface for the stem pipes 122 provided at the open end interface and end cap at the top of the filter cartridge 230.

In this embodiment, it can also be seen that the low efficiency filter element 232 has filter media 134 which in this embodiment extends a full length of the filter cartridge between the open end cap 138 and the closed end cap 142 which may be the same as in the first embodiment. However, it can also be seen that the bypass cylinder 288 is located off a boss region in the closed end cap 142 in this embodiment and likewise, the solid cylindrical flow pipe 204 at the other end is located off of the inner flange which defines the opening within the open end cap 138 in this design. These structures may be welded or otherwise located interfit with the end caps 200, 202 of the high efficiency filter element 210.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter cartridge, comprising:
a pair of end caps, at least one of the end caps having an opening providing a fluid port;
a low efficiency filter element interposed between the end caps;
a high efficiency filter element interposed between the end caps, the high efficiency filter element having a filter media of a higher efficiency than the low efficiency filter element; and
the filter cartridge is configured for a locomotive lubrication system wherein the filter cartridge having an axial length of at least about 18 inches.

2. The filter cartridge of claim 1, further comprising:
a flow divider interposed between the end caps and dividing a flow path through at least the high efficiency filter element, wherein a first portion of the flow along the flow path passes through the high efficiency filter element and a second portion of flow along the flow path bypasses the high efficiency filter element.

3. The filter cartridge of claim 2, wherein high efficiency filter element includes a first tubular filter media ring and the low efficiency filter element includes a second tubular filter media ring, the first and second tubular filter media rings being arranged in parallel circuit, respective ends of the high efficiency filter element and the low efficiency filter element being in end to end relation, the flow divider being provided by a venturi tube arranged within the first tubular filter media ring of the high efficiency filter element with an axial flow path therealong with a restriction section, the axial flow path receiving flow from the second tubular ring of the low efficiency filter element, the venturi tube including at least one flow opening proximate the restriction section to suction fluid through the high efficiency filter element and into the axial flow path via the venturi effect.

4. The filter cartridge of claim 1, wherein one of the end caps is a closed end cap and the other is an open end cap; further comprising at least two seals carried by the open end cap in surrounding relation of a central opening in the open end cap, each of the seals adapted to seal against a housing having a stem pipe interface.

5. The filter cartridge of claim 1 wherein the first cartridge does not include a housing but has an open outer periphery for fluid flow therethrough, the filter cartridge further including an outer perforated wrapper in surrounding relation to the high efficiency and low efficiency filter elements and interposed between end caps.

7. The filter cartridge of claim 5, further comprising a divider end cap axially between the high efficiency filter element and the low efficiency filter element.

8. The filter cartridge of claim 1, wherein the cartridge has an axial length of at least about 24 inches, an outer diameter of at least about 6 inches, and an inner diameter of greater than about 2 inches, the filter cartridge having a strength characteristic of at least about 100 PSI fluid pressure, a flow capacity of at least 45 GPM with an initial pressure drop of no greater than 3 PSI at a system fluid pressure of 95 PSI.

9. The filter cartridge of claim 1, wherein the low efficiency filter element has an efficiency rating for particulate removal of greater than 10 micron, and wherein the high efficiency filter element has an efficiency rating for soot removal in locomotive lubrication systems that is less than 10 micron, and that is less than ½ the efficiency rating of the low efficiency filter element.

10. The filter cartridge of claim 9, wherein the low efficiency filter element comprises a pleated tubular ring of filter media, and wherein the high efficiency element comprises a ring of depth media, the depth media comprising a media thickness of at least about ½ inch for trapping soot throughout the ½ depth thereof.

11. A filter cartridge, comprising
a pair of end caps, at least one of the end caps having an opening providing a fluid port;
a low efficiency filter element interposed between the end caps; and
a high efficiency filter element interposed between the end caps, the high efficiency filter element having a filter media of a higher efficiency than the low efficiency filter element, and wherein the high efficiency element comprises a ring of depth media, the depth media comprising a media thickness of at least about ¼ inch for trapping contaminants throughout the ¼ depth thereof; wherein at least a portion of a flow path through the filter cartridge bypasses the high efficiency filter element.

12. The filter cartridge of claim 11, wherein the low efficiency filter element has an efficiency rating for particulate removal of greater than 10 micron, and wherein the high efficiency filter element has a efficiency rating for soot removal in locomotive lubrication systems that is less than 10 micron, and that is less than ½ of the efficiency rating of the low efficiency filter element.

13. The filter cartridge of claim 12, further comprising:
a flow divider interposed between the end caps and dividing a flow path through at least the high efficiency filter element, wherein a first portion of the flow along the flow path passes through the high efficiency filter element and a second portion of flow along the flow path bypasses the high efficiency filter element.

14. The filter cartridge of claim 13, wherein high efficiency filter element includes a first tubular filter media ring and the low efficiency filter element includes a second tubular filter media ring, the first and second tubular filter media rings being arranged in parallel circuit, respective ends of the high efficiency filter element and the low efficiency filter element being in end to end relation, the flow divider being provided by a venturi tube arranged within the first tubular filter media ring of the high efficiency filter element with an axial flow path therealong with a restriction section, the axial flow path receiving flow from the second tubular ring of the low efficiency filter element, the venturi tube including at least one flow opening proximate the restriction section to suction fluid through the high efficiency filter element and into the axial flow path via the venturi effect.

15. The filter cartridge of claim 14, wherein one of the end cap is a closed end cap and the other is an open end cap; further comprising at least two seals carried by the open end cap in surrounding relation of a central opening in the open end cap, each of the seals adapted to seal against a housing having a stem pipe interface.

16. The filter cartridge of claim 11, wherein the cartridge has an axial length of at least about 24 inches, an outer diameter of at least about 6 inches, and an inner diameter of less than about 2 inches, the filter cartridge having a strength characteristic of at least about 100 PSI fluid pressure.

17. The filter cartridge of claim 11, wherein the depth media comprises at least 5 filter media layers formed by one or more media strips wrapped successively around one another throughout the media thickness.

18. The filter cartridge of claim 11, wherein the depth media of the high efficiency filter element comprises less than ½ of length of filter media of the low efficiency filter element.

19. A locomotive filtration system, comprising:
a housing defining a filtration chamber, the housing having an inlet and an outlet in commemoration with a lubricated circuit of a locomotive, a manifold having a plurality of fluid ports along the fluid chamber connected to one of the inlet and the outlet, wherein a flow passage extends from the inlet through the filtration chamber and to the outlet;
a plurality of low efficiency filter elements arranged in parallel circuit with each other;
a plurality of high efficiency filter elements, the high efficiency filter elements having a filter media of a higher efficiency than the low efficiency filter elements, the high efficiency filter elements arranged in parallel circuit with each other; and
the high efficiency filter elements and the low efficiency filter elements being commonly mounted within the filtration chamber of the housing along the flow passage for filtering fluid flowing along the flow passage.

20. The locomotive filtration system of claim 19, wherein pairs of high efficiency filter elements and low efficiency filter element are provided in a plurality of filter cartridges that are installable and removable from the housing, each filter cartridge including:
a pair of end caps, at least one of the end caps having an opening providing a fluid port;
at least one of the low efficiency filter elements interposed between the end caps;
at least one of the high efficiency filter elements interposed between the end caps, the high efficiency filter element having a filter media of a higher efficiency than the low efficiency filter element; and
wherein the filter cartridge having an axial length of at least about 18 inches.

21. The locomotive filtration system of claim 19, wherein each filter cartridge further comprises:
a flow divider interposed between the end caps and dividing a flow path through at least the high efficiency filter element wherein a first portion of the flow along the flow path passes through the high efficiency filter element and a second portion of flow along the flow path bypasses the high efficiency filter element, with at least about 50% passing through the low efficiency filter element, and no more than about 50% passing through the high efficiency filter element.

22. The locomotive filtration system of claim 21, wherein high efficiency filter element includes a first tubular filter media ring and the low efficiency filter element includes a second tubular filter media ring, the first and second tubular filter media rings being arranged in parallel circuit, respective ends of the high efficiency filter element and the low efficiency filter element being in end to end relation, the flow divider being provided by a venturi tube arranged within the first tubular filter media ring of the high efficiency filter element with an axial flow path therealong with a restriction section, the axial flow path receiving flow from the second tubular ring of the low efficiency filter element, the venturi tube including at least one flow opening proximate the restriction section to suction fluid through the high efficiency filter element and into the axial flow path via the venturi effect, and further comprising a divider end cap axially between the high efficiency filter element and the low efficiency filter element.

23. The locomotive filtration system of claim 20, wherein one of the end caps is a closed end cap and the other is an open end cap; further comprising at least two seals carried by the open end cap in surrounding relation of a central opening in the end cap, each of the seals adapted to seal against a housing having a stem pipe interface.

24. The locomotive filtration system of claim 20, wherein the first cartridge does not include a housing but has an open outer periphery for fluid flow therethrough, the filter cartridge further including an outer perforated wrapper in surrounding relation to the high efficiency and low efficiency filter elements and interposed between end caps, each of the filter cartridges being mounted in parallel fluid circuit with each other.

25. The locomotive filtration system of claim 20, wherein each cartridge has an axial length of at least about 24 inches, an outer diameter of at least about 6 inches, and an inner diameter of greater than about 2 inches, the filter cartridge having a strength characteristic of at least about 100 PSI fluid pressure.

26. The filter cartridge of claim 25, wherein the low efficiency filter element comprises a pleated tubular ring of filter media, and wherein the high efficiency element comprises a ring of depth media, the depth media comprising a media thickness of at least about ½ inch for trapping soot throughout the ½ depth thereof.

27. The filter cartridge of claim 19, wherein the low efficiency filter elements have an efficiency rating for particulate removal of greater than 10 micron, and wherein the high efficiency filter element has a efficiency rating for soot removal in locomotive lubrication systems that is less than 10 micron.

28. The filter cartridge of claim 2, wherein the low efficiency filter element is in series with the high efficiency filter element, wherein 100 percent of the flow path passes through the low efficiency filter element and the flow divider has a bypass for the second portion in parallel with the high efficiency filter element.

29. The filter cartridge of claim 13, wherein the low efficiency filter element is in series with the high efficiency filter element, wherein 100 percent of the flow path passes through the low efficiency filter element and the flow divider has a bypass for the second portion in parallel with the high efficiency filter element.

30. The filter cartridge of claim 21, wherein the low efficiency filter element is in series with the high efficiency filter element, wherein 100 percent of the flow path passes through the low efficiency filter element and the flow divider has a bypass for the second portion in parallel with the high efficiency filter element.
